(19) United States
(12) Patent Application Publication
(10) Pub. No.: US 2021/0064947 A1
(43) Pub. Date: Mar. 4, 2021

(54) IMAGE FORMING APPARATUS AND CONTROL PROGRAM FOR IMAGE FORMING APPARATUS

(71) Applicant: Konica Minolta, Inc., Tokyo (JP)

(72) Inventor: Ken MIYAZAKI, Sagamihara-shi (JP)

(73) Assignee: Konica Minolta, Inc., Tokyo (JP)

(21) Appl. No.: 16/994,985

(22) Filed: Aug. 17, 2020

(30) Foreign Application Priority Data
Sep. 2, 2019 (JP) 2019-159773

(51) Int. Cl. G06K 15/02; B41N 3/00; B41F 33/00

(52) U.S. Cl. CPC G06K 15/1868; B41N 3/00; B41P 2219/20; B41F 33/00; G06K 15/021

(57) ABSTRACT

An image forming apparatus includes: an image former; and a hardware processor that outputs information on a calculation result of a total length, in a paper conveyance directions, of an image part formed at a time of executing a print job by causing the image former to print the information in mirror writing.

The entire disclosure of Japanese patent Application No. 2019-159773, filed on Sep. 2, 2019, is incorporated herein by reference in its entirety.

### BACKGROUND

### Technological Field

The present invention relates to an image forming apparatus and a control program for the image forming apparatus.

### Description of the Related Art

There is known a technique of foil stamping printing. In the technique, paper on which a toner image has been formed is made to overlap foil, and heated and pressurized. Foil is thus transferred to the toner image. Since foil used in foil stamping printing is awfully expensive, a technique for reducing wasteful consumption of foil is required. For example, if foil is used up in the part of the way of transfer to paper, paper onto which foil has been transferred in the part of the way is wasted, and the foil that has been transferred to the paper in the part of the way is also wasted. Techniques of preventing such a situation are required. For example, JP 2018-69659 A discloses a technique of determining whether a print job can be completed based on a foil usage amount calculated based on the print job and a remaining amount of a foil roll.

In the technique disclosed in JP 2018-69659 A, the remaining amount of a foil roll is acquired by subtracting the length of the foil roll used in foil stamping printing from the length of the mounted foil roll. For example, in the case where the remaining amount of the foil roll at the time of mounting is unknown, such as the case where a foil roll that was used in the past is mounted again, there is a risk of whether the foil is sufficient being not properly determined.

### SUMMARY

The invention has been made in view of the above-described problem. An object of the invention is to provide an image forming apparatus and a control program for the image forming apparatus, which allow an operator to accurately grasp a remaining amount of a foil roll to be used in foil stamping printing.

To achieve the abovementioned object, according to an aspect of the present invention, an image forming apparatus reflecting one aspect of the present invention comprises: an image former; and a hardware processor that outputs information on a calculation result of a total length, in a paper conveyance direction, of an image part formed at a time of executing a print job by causing the image former to print the information in mirror writing.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 illustrates the schematic configuration of an image forming system according to one embodiment of the invention;

FIG. 2 is a block diagram illustrating the schematic configuration of an image forming apparatus;

FIG. 3 is a block diagram illustrating the functional configuration of a controller of the image forming apparatus;

FIG. 4 illustrates a method of calculating predetermined lengths regarding a print job;

FIG. 5 is a flowchart illustrating one example of the procedure of processing of the image forming apparatus;

FIG. 6 illustrates one example of a setting screen regarding output of predetermined lengths regarding a print job; and

FIG. 7 illustrates a method of outputting information on a calculation result of predetermined lengths regarding a print job.

### DETAILED DESCRIPTION OF EMBODIMENTS

Hereinafter, one or more embodiments of the present invention will be described with reference to the drawings. However, the scope of the invention is not limited to the disclosed embodiments. In the description of the drawings, the same elements are denoted by the same signs, and redundant description will be omitted. The ratio of dimensions in the drawings is exaggerated for convenience of description, and may be different from the actual ratio.

(Image Forming System)

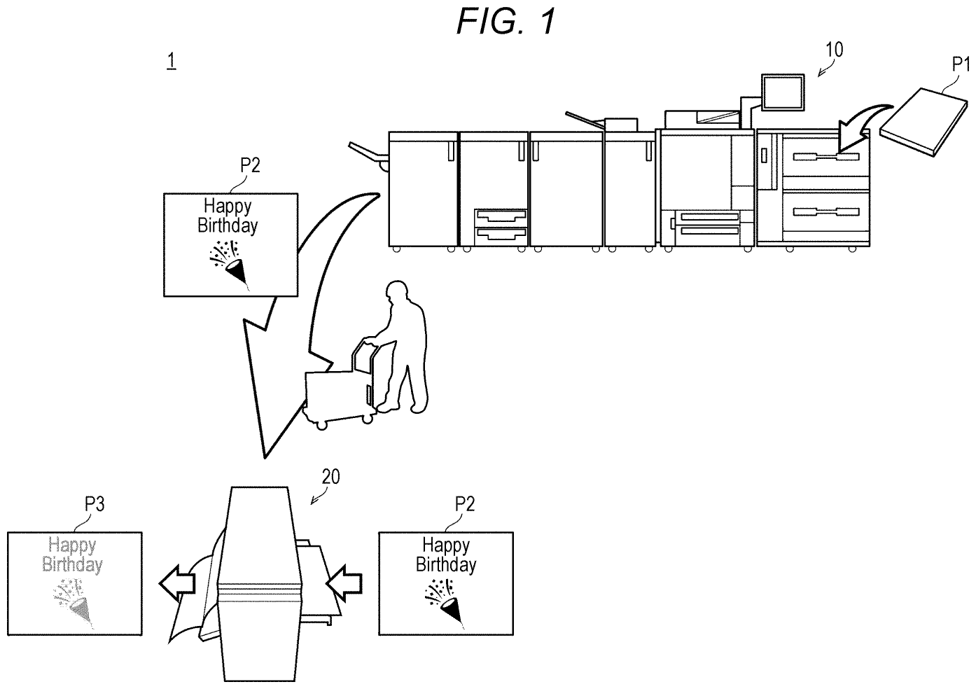

FIG. 1 illustrates the schematic configuration of an image forming system according to one embodiment of the invention.

As illustrated in FIG. 1, an image forming system 1 includes an image forming apparatus 10 and a foil stamping apparatus 20.

The image forming apparatus 10 forms a toner image on paper P1, and outputs paper P2 on which the toner image is formed. Foil is to be transferred to the toner image in foil stamping printing. An operator of the foil stamping printing manually carries the paper P2 on which the toner image is formed, and sets the paper P2 in the foil stamping apparatus 20.

The foil stamping apparatus 20 causes the paper P2 on which the toner image is formed to overlap, for example, a roll of foil, and heats and pressurizes the paper P2 overlapping the foil. The foil stamping apparatus 20 transfers the foil to the toner image by using melted toner as an adhesive. The foil stamping apparatus 20 outputs final printed matter P3 on which the foil has been transferred. The foil stamping apparatus 20 may have a function of detecting a portion of the toner image formed on the paper P2 and conveying foil in accordance with the portion of the toner image.

(Image Forming Apparatus)

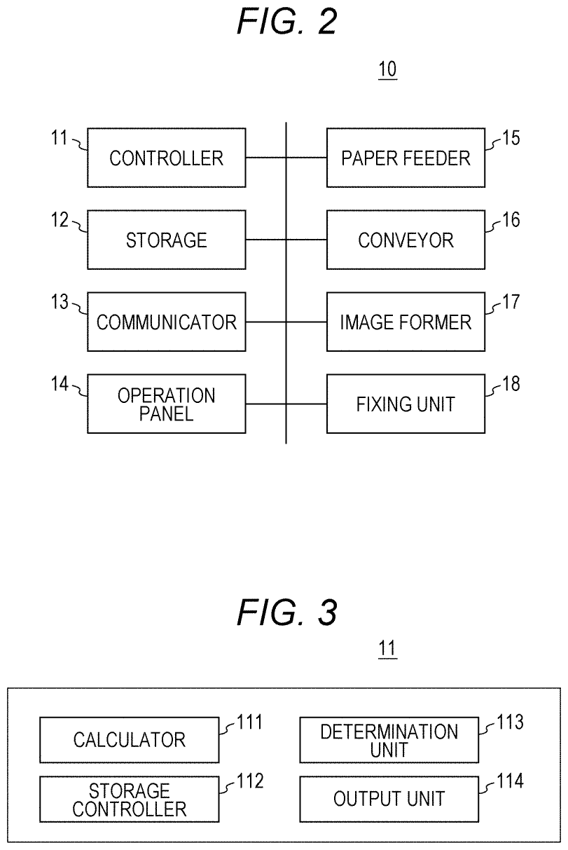

Details of the image forming apparatus 10 will be described. FIG. 2 is a block diagram illustrating the schematic configuration of the image forming apparatus.

As illustrated in FIG. 2, the image forming apparatus 10 includes a controller 11, a storage 12, a communicator 13, an operation panel 14, a paper feeder 15, a conveyor 16, an image former 17, and a fixing unit 18. These components are mutually connected via a bus for communicating signals.

The controller 11 includes a central processing unit (CPU), and executes control of each of the above-described components and various pieces of arithmetic processing in accordance with a program. The functional configuration of the controller 11 will be described later with reference to FIG. 3.

The storage 12 includes a read only memory (ROM), a random access memory (RAM), and a hard disk. Various programs and various pieces of data are preliminarily stored in the ROM. A program and data are temporarily stored in the RAM as a work area. Various programs and various pieces of data are store in the hard disk. The storage 12 temporarily saves (stores) a print job for foil stamping printing, for example.

The communicator 13 includes an interface for communicating with other devices such as a personal computer (PC). The communicator 13 receives a print job from, for example, a PC used by an operator.

The operation panel 14 includes a touch panel, a numeric keypad, a start button, and a stop button. The operation panel 14 displays various pieces of information as a display, and receives various operations as an operation receiver.

The paper feeder 15 includes a paper feed tray that accommodates paper to be used for printing, and feeds the paper stored in the paper feed tray one by one. The paper feeder 15 may accommodate and feed continuous paper, or may feed continuous paper from, for example, a manual feed tray and another paper feeding apparatus.

The conveyor 16 includes a conveyance path, a plurality of conveyance rollers, and a drive motor. The plurality of conveyance roller is disposed along the conveyance path. The drive motor drives the conveyance rollers. The conveyor 16 conveys the paper fed by the paper feeder 15 along the conveyance path.

The image former 17 forms an image on the paper conveyed by the conveyor 16 by a well-known image creating process such as an electrophotographic process.

The fixing unit 18 includes a heating roller and a pressure roller. The fixing unit 18 heats and pressurizes the paper conveyed by the conveyor 16. An image has been formed by the image former 17 on the paper. The fixing unit 18 fixes the image on the paper.

The image forming system 1 and the image forming apparatus 10 may include a component other than the above-described components, and is not required to include all of the above-described components.

(Controller)

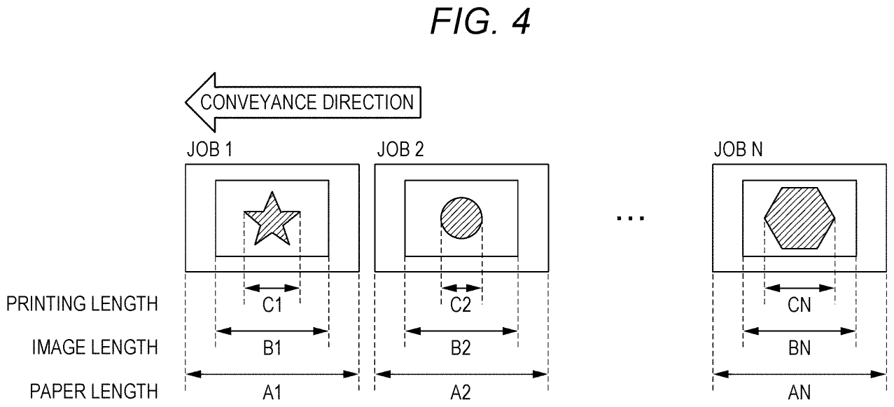

FIG. 3 is a block diagram illustrating the functional configuration of the controller of the image forming apparatus. FIG. 4 illustrates a method of calculating predetermined lengths regarding a print job.

As illustrated in FIG. 3, the controller 11 reads a program, and executes processing. The controller 11 thus functions as a calculator 111, a storage controller 112, a determination unit 113, and an output unit 114.

The calculator 111 calculates predetermined lengths regarding a print job in a paper conveyance direction. The calculator 111 calculates the total length (hereinafter, also referred to as a “total paper length”), in the conveyance direction, of paper conveyed at the time of executing the print job as illustrated in, for example, FIG. 4. The calculator 111 calculates the total length (hereinafter, also referred to as a “total image length”), in the paper conveyance direction, of a maximum area in which an image can be formed at the time of executing the print job. The maximum area in which an image can be formed corresponds to, for example, an image size. The calculator 111 calculates the total length (hereinafter, also referred to as a “total printing length”), in the paper conveyance direction, of an image part (printing part) actually formed at the time of executing the print job. In the example in FIG. 4, the total paper lengths of A1+A2+ . . . +AN, the total image length of B1+B2+ . . . +BN, and the total printing length of C1+C2+ . . . +CN are calculated as predetermined lengths regarding jobs 1, 2, . . . , and N.

The storage controller 112 causes the storage 12 to store the calculation result of the predetermined lengths regarding the print job.

The determination unit 113 makes various determinations. For example, the determination unit 113 determines whether or not an operator operation has been received on the operation panel 14.

The output unit 114 outputs information on the calculation result of the predetermined lengths regarding the print job. For example, the output unit 114 outputs information on the calculation result of the predetermined lengths by causing the image former 17 to print the information.

(Processing)

The procedure of processing of the image forming apparatus 10 will be described. The image forming apparatus 10 performs processing of controlling a remaining amount of foil roll to be used in foil stamping printing so that an operator accurately grasps the amount.

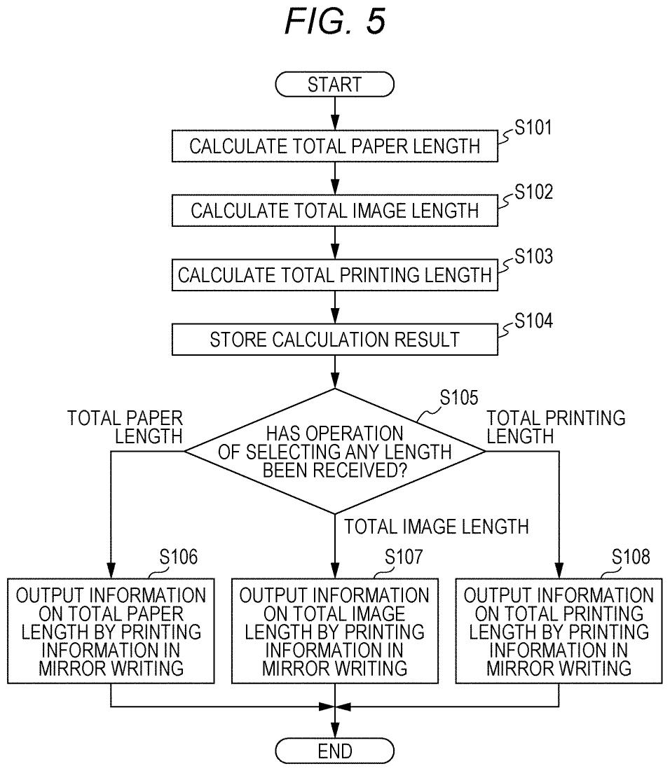

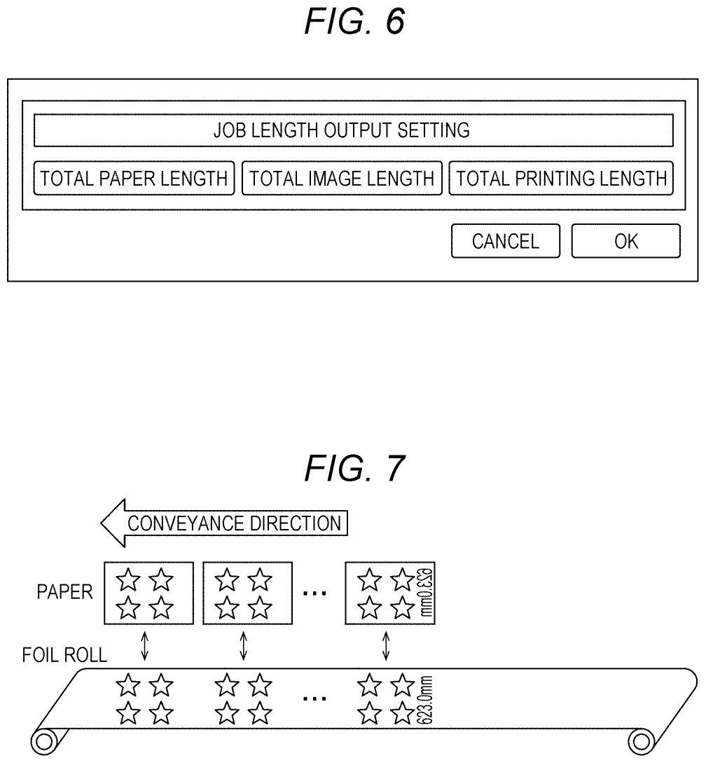

FIG. 5 is a flowchart illustrating one example of the procedure of processing of the image forming apparatus. The algorithm in the flowchart of FIG. 5 is stored in the storage 12 as a program, and executed by the controller 11. FIG. 6 illustrates one example of a setting screen regarding output of predetermined lengths regarding a print job. FIG. 7 illustrates a method of outputting information on a calculation result of predetermined lengths regarding a print job.

As illustrated in FIG. 5, when receiving a print job, the controller 11 first calculates a predetermined length regarding a print job in the paper conveyance direction as the calculator 111. More specifically, the controller 11 calculates the total paper length in the paper conveyance direction (Step S101). The controller 11 calculates the total image length in the paper conveyance direction (Step S102). The controller 11 calculates the total printing length in the paper conveyance direction (Step S103). The order of Steps S101 to S103 is not limited to the example in FIG. 5, and may be changed.

The controller 11 causes the storage 12 to store the calculation results in Steps S101 to S103 as the storage controller 112 (Step S104). The controller 11 determines, as the determination unit 113, whether an operator operation of selecting any of the total paper length, the total image length, and the total printing length has been received on, for example, the setting screen as illustrated in FIG. 6, which is displayed on the operation panel 14 (Step S105).

The total paper length is selected, for example, when the foil stamping apparatus 20 is used. The foil stamping apparatus 20 conveys foil accompanying the conveyance of paper (sheet). When the foil stamping apparatus 20 above is used, the foil usage amount corresponds to a total conveyance amount of paper, that is, the total paper length. In the case, the operator can check the foil usage amount by checking the total paper length.

The total image length is selected, for example, when the foil stamping apparatus 20 is used. The foil stamping apparatus 20 conveys foil accompanying the conveyance of continuous paper (e.g., roll paper). When the foil stamping apparatus 20 above is used, the foil usage amount corresponds to a total conveyance amount of continuous paper, that is, the total image length. In the case, the operator can check the foil usage amount by checking the total image length.

The total printing length is selected, for example, when the foil stamping apparatus 20 is used. The foil stamping apparatus 20 detects an image part formed on paper, and conveys foil in accordance with the image part. When the foil stamping apparatus 20 above is used, the foil usage amount corresponds to a total length of the image part, that is, the total printing length. In the case, the operator can check the foil usage amount by checking the total printing length.

The controller 11 outputs, as the output unit 114, information on a calculation result of a predetermined length regarding a print job based on the determination result in Step S105 by causing the image former 17 to print the information in mirror writing. More specifically, when determining that an operation of selecting the total paper length has been received, the controller 11 outputs the information on the calculation result of the total paper length by causing the image former 17 to print the information in mirror writing (Step S106). When determining that an operation of selecting the total image length is received, the controller 11 outputs information on the calculation result of the total image length by causing the image former 17 to print the information in mirror writing (Step S107). When determining that an operation of selecting the total printing length has been received, the controller 11 outputs the information on the calculation result of the total printing length by causing the image former 17 to print the information in mirror writing (Step S108). The controller 11 then ends the processing.

For example, as illustrated in FIG. 7, the controller 11 controls the image former 17 so that the image former 17 prints information on the calculation result of a predetermined length regarding a print job in mirror writing on paper on which an image is formed. Foil is to be transferred to the image. The information, expressed in mirror writing, on the calculation result of a predetermined length may be combined with the image to which foil is to be transferred, and then printed together with the image to which foil is to be transferred. As a result, in foil stamping printing, foil is transferred not only to the toner image but to the mirror writing. Foil of a part corresponding to the mirror writing is also removed from a foil roll. In the embodiment, the information on the calculation result of a predetermined length is printed in mirror writing so that the operator can recognize the character removed from the foil roll as a character in the normal orientation. When not a foil roll in an initial state but a foil roll from which a character is removed is used, the operator can grasp a remaining amount of the foil roll in the part of the way of usage, for example, by subtracting the length indicated by the removed character from the initial length of the foil roll. The information on the calculation result of a predetermined length is preferably printed at a position of, for example, an edge portion of paper or a portion to be wasted of paper so that formation of the image on which foil is to be transferred is not prevented. The printing position may be allowed to be adjusted by the operator. Although, in the example in FIG. 7, the information on the calculation result of a predetermined length is printed in units of meters, the information may be printed in other units of, for example, inches and feet.

For example, the controller 11 controls the image former 17 so that the image former 17 prints information on the calculation result of a predetermined length regarding the print job on paper which is conveyed first or last at the time of executing the print job. More specifically, for example, as illustrated in FIG. 7, when foil is last transferred to paper which is last conveyed at the time of executing a print job, the controller 11 controls the image former 17 so that the image former 17 prints the information on the calculation result of a predetermined length on the paper which is last conveyed. Here, the “paper which is last conveyed” is paper of Nth page in the case of, for example, 1 to N printing. In the case of N to 1 printing, the “paper which is last conveyed” may be paper of the first page. When foil is last transferred to paper which is first conveyed at the time of executing a print job, the controller 11 controls the image former 17 so that the image former 17 prints information on the calculation result of a predetermined length on the paper which is first conveyed. As a result, the character removed from the foil roll is positioned near the rear end of a usage area of the foil roll. The operator can easily grasp the remaining amount of the foil roll only by looking at the foil roll.

The embodiment has the following effects.

The image forming apparatus 10 calculates the total length, in the paper conveyance direction, of an image part formed at the time of executing a print job, and outputs the information on the calculation result by printing the information in mirror writing. When the foil stamping apparatus 20 that detects an image part and transfers foil in accordance with the image part as the foil stamping apparatus 20 that transfers foil to the image, the foil usage amount corresponds to the total length of the image part. The image forming apparatus 10 enables the operator to check the information on the total length of the image part contained in the character removed from the foil roll, and enables the operator to accurately grasp the remaining amount of the foil roll to be used in foil stamping printing.

The image forming apparatus 10 further outputs information on the calculation result of the total length of a maximum area in which an image can be formed or the total length of paper. The image forming apparatus 10 enables the operator to accurately grasp the remaining amount of foil to be used in foil stamping printing by causing the operator to check information on various lengths regarding the print job in accordance with the type of the foil stamping apparatus 20.

The image forming apparatus 10 prints information on the calculation result of a predetermined length regarding a print job on paper which is conveyed first or last at the time of executing the print job. As a result, even when the image forming apparatus 10 executes a print job including a plurality of pages, a character removed from the foil roll is positioned near the rear end of a usage area of the foil roll. The operator can easily grasp the remaining amount of the foil roll only by looking at the foil roll.

The invention is not limited to the above-described embodiment, and various modifications, improvements, and the like can be made within the scope of the claims.

(Variation 1)

In the above-described embodiment, the case where the image forming apparatus 10 outputs the calculation result of a predetermined length as it is as information on the calculation result of a predetermined length regarding a print job has been described by way of example. The image forming apparatus 10 may output another piece of information calculated based on the calculation result of a predetermined length.

More specifically, the controller 11 of the image forming apparatus 10 may receive an operator operation of inputting the length of a foil roll mounted in the foil stamping apparatus 20 via the operation panel 14 that functions as a first operation receiver. When determining that the operator operation is received, the controller 11 may further calculate the difference between the input length of the foil roll and the predetermined length calculated in Steps S101 to S103, that is, the remaining amount of the foil roll. That is, the controller 11 further calculates the difference between the input length of the foil roll and the calculated total paper length, total image length, or total printing length. The controller 11 may output information on the calculated difference as the information on the calculation result of a predetermined length. This enables the operator to grasp the remaining amount of the foil roll more intuitively.

(Variation 2)

In the above-described embodiment, a case has been described by way of example. In the case, information on the calculation result of a predetermined length regarding a print job is printed in mirror writing on a side (front side) of paper on which an image is formed. Foil is to be transferred to the image. Foil of a part corresponding to the mirror writing is removed from the foil roll. Information on the calculation result of a predetermined length, however, may be printed on a side (back side) of paper different from the side where an image is formed in a character in the normal orientation (normal character). Foil is to be transferred to the image.

More specifically, the controller 11 of the image forming apparatus 10 may control the image former 17 so that the image former 17 prints the information on the calculation result of a predetermined length on the front or back side of paper. In the case, the controller 11 may receive an operator operation of selecting a side of paper to which the information on the calculation result of a predetermined length is input via the operation panel 14. The controller 11 may control the image former 17 so that the image former 17 prints the information on the calculation result of a predetermined length on the selected side of paper.

When the information on the calculation result of a predetermined length is printed on the front side of paper, the controller 11 may control the image former 17 so that the image former 17 prints the information in mirror writing. When the information is printed on the back side of the paper, the controller 11 may control the image former 17 so that the image former 17 prints the information in a normal character. As described above, when the information on the calculation result of a predetermined length is printed on the front side of paper, the information is printed in mirror writing so that an operator can recognize a character removed from the foil roll as a normal character. When the information on the calculation result of a predetermined length is printed on the back side of the paper, however, foil corresponding to the printed character is not removed from the foil roll. The information thus does not need to be printed in mirror writing, and is printed in a normal character. As a result, even when the information on the calculation result of a predetermined length is not printed on the front side of paper, the operator can easily check the information on the printed calculation result of a predetermined length by turning over the output paper. The image forming apparatus 10 is not necessarily required to transfer foil to the printed information on the calculation result of a predetermined length, so that wasteful consumption of foil can be inhibited.

In the above-described embodiment, a case has been described by way of example. In the case, the image forming apparatus 10 prints information on the calculation result of a predetermined length regarding a print job on paper which is conveyed first or last at the time of executing the print job. The image forming apparatus 10, however, may print the information on the calculation result on partition paper inserted immediately before paper which is first conveyed or immediately after paper which is last conveyed at the time of executing the print job. As a result, even when information on the calculation result of a predetermined length cannot be directly printed on paper on which an image based on the print job, that is, an image to which foil is to be transferred is formed, the image forming apparatus 10 can print the information on partition paper. The image forming apparatus 10 thus enables the operator to check the information.

In the above-described embodiment, the case where the image forming apparatus 10 automatically outputs the information on the calculation result of a predetermined length regarding a print job has been described by way of example. The image forming apparatus 10, however, may output the information on the calculation result of a predetermined length based on an operator operation of validating output of information on the calculation result of a predetermined length. More specifically, the controller 11 of the image forming apparatus 10 may receive an operator operation of validating or invalidating the output of information on the calculation result of a predetermined length via the operation panel 14 that functions as a second operation receiver. The controller 11 may output information on the calculation result of a predetermined length only when receiving an operator operation of validating the output. As a result, the image forming apparatus 10 can output the information on the calculation result of a predetermined length based on an operator instruction.

In the above-described embodiment, the case where the image forming apparatus 10 calculates the total paper length, the total image length, and the total printing length as a predetermined length regarding a print job has been described by way of example. The image forming apparatus 10, however, is not required to calculate all of the total paper length, the total image length, and the total printing length. For example, the image forming apparatus 10 may receive an operator operation of selecting any of the total paper length, the total image length, and the total printing length before calculating the predetermined length regarding a print job, and calculate only the length selected by the operator.

In the above-described embodiment, the case where the image forming apparatus 10 outputs information on the calculation result of any of the total paper length, the total image length, and the total printing length selected by the operator has been described by way of example. The image forming apparatus 10, however, may simultaneously output information on the calculation result of a plurality of lengths from the beginning.

In the above-described embodiment, the case where the image forming apparatus 10 forms an image by using toner has been described by way of example. Foil is to be transferred to the image. The image forming apparatus 10, however, may be an inkjet printer. The image forming apparatus 10 may form an image, to which foil is to be transferred, by using varnish instead of ink.

The processing according to the above-described embodiment may include a step other than the above-described steps, and is not required to include all of the above-described steps. The order of the steps is not limited to the above-described embodiment. Each step may be combined with another step, and executed as one step. Each step may be included in another step, and executed. Each step may be divided into a plurality of steps, and executed. Each step may be executed at the same time as another step.

A device and method of performing various pieces of processing in the image forming apparatus 10 according to the above-described embodiment may be achieved by any of a dedicated hardware circuit and a programmed computer. For example, the above-described program may be provided by a computer-readable recording medium such as a compact disc read only memory (CD-ROM), or may be provided online via a network such as the Internet. In the case, the program recorded on the computer-readable recording medium is usually transferred and stored in a storage such as a hard disk. The above-described program may be provided as independent application software, or may be incorporated in the software as one function of the image forming apparatus 10.

Although embodiments of the present invention have been described and illustrated in detail, the disclosed embodiments are made for purposes of illustration and example only and not limitation The scope of the present invention should be interpreted by terms of the appended claims.

What is claimed is:

1. An image forming apparatus comprising:
an image former; and
a hardware processor that outputs information on a calculation result of a total length, in a paper conveyance direction, of an image part formed at a time of executing a print job by causing the image former to print the information in mirror writing.

2. The image forming apparatus according to claim 1,
wherein the hardware processor calculates a total length of the image part, and outputs information on a calculation result of a total length of the image part.

3. The image forming apparatus according to claim 2,
wherein the hardware processor further calculates a total length, in the conveyance direction, of the paper conveyed at a time of executing the print job or a total length, in the conveyance direction, of a maximum area in which an image is allowed to be formed at a time of executing the print job, and
further outputs information on a calculation result of the total length of the paper or the total length of a maximum area in which an image is allowed to be formed.

4. The image forming apparatus according to claim 3, further comprising a first operation receiver,
wherein, when an operator operation of inputting a length of a foil roll mounted in a foil stamping apparatus is received at the first operation receiver, the hardware processor further calculates difference between the input length of the foil roll and the calculated total length of the image part, the total length of the paper, or the total length of the maximum area in which the image is allowed to be formed, and
outputs information on the difference as information on the calculation result.

5. The image forming apparatus according to claim 1,
wherein the hardware processor controls the image former so that the image former prints information on the calculation result on the paper which is conveyed first or last at a time of executing the print job.

6. The image forming apparatus according to claim 1,
wherein the hardware processor controls the image former so that the image former prints information on the calculation result on a front side or back side of the paper, controls the image former so that the image former performs printing in the mirror writing in a case where the front side of the paper is printed, and controls the image former so that the image former performs printing in a normal character in a case where the back side of the paper is printed.

7. The image forming apparatus according to claim 1,
wherein the hardware processor controls the image former so that the image former prints information on the calculation result on partition paper inserted immediately before the paper which is first conveyed or immediately after the paper which is last conveyed at a time of executing the print job.

8. The image forming apparatus according to claim 1, further comprising a second operation receiver,
wherein, when an operator operation of validating output of information on the calculation result is received at the second operation receiver, the hardware processor outputs the information on the calculation result.

9. A non-transitory recording medium storing a computer readable control program for an image forming apparatus including an image former, the control program causing a computer to perform processing including outputting information on a calculation result of a total length, in a paper conveyance direction, of an image part formed at a time of executing a print job by causing the image former to print the information in mirror writing.

10. The non-transitory recording medium storing a computer readable control program according to claim 9,
wherein the processing further includes calculating the total length of the image part, and
in the inputting, information on a calculation result of the total length of the image part in the calculating is input.

11. The non-transitory recording medium storing a computer readable control program according to claim 10,
wherein, in the calculating, a total length, in the conveyance direction, of the paper conveyed at a time of executing the print job or a total length, in the conveyance direction, of a maximum area in which an image is allowed to be formed at a time of executing the print job is further calculated, and
in the outputting, information on a calculation result of the total length of the paper or the total length of a maximum area in which an image is allowed to be formed in the calculating is further output.

12. The non-transitory recording medium storing a computer readable control program according to claim 11,
wherein, in the calculating, when an operator operation of inputting a length of a foil roll mounted in a foil stamping apparatus is received at the first operation receiver in the image forming apparatus, difference between the input length of the foil roll and the calculated total length of the image part, the total length of the paper, or the total length of the maximum area in which the image is allowed to be formed is further calculated, and
in the outputting, information on the difference is output as information on the calculation result.

13. The non-transitory recording medium storing a computer readable control program according to claim 9,
wherein, in the outputting, the image former is controlled so as to print information on the calculation result on the paper which is conveyed first or last at a time of executing the print job.

14. The non-transitory recording medium storing a computer readable control program according to claim 9,
wherein, in the outputting, the image former is controlled so as to print information on the calculation result on a front side or back side of the paper, the image former is controlled so as to perform printing in the mirror writing in a case where the front side of the paper is printed, and the image former is controlled so as to perform printing in a normal character in a case where the back side of the paper is printed.

15. The non-transitory recording medium storing a computer readable control program according to claim 9,
wherein, in the outputting, the image former is controlled so as to print information on the calculation result on partition paper inserted immediately before the paper which is first conveyed or immediately after the paper which is last conveyed at a time of executing the print job.

16. The non-transitory recording medium storing a computer readable control program according to claim 9,
wherein, in the outputting, when an operator operation of validating output of information on the calculation result is received at the second operation receiver provided in the image forming apparatus, the information on the calculation result is output.
